(19) United States
(12) Patent Application Publication
(10) Pub. No.: US 2014/0248507 A1
(43) Pub. Date: Sep. 4, 2014

(54) ANTI-REFLECTIVE COATING

(71) Applicant: Vladimir Kleptsyn, Brookline, MA (US)

(72) Inventor: Vladimir Kleptsyn, Brookline, MA (US)

(21) Appl. No.: 13/781,774

(22) Filed: Mar. 1, 2013

(51) Int. Cl. C09D 5/00

(52) U.S. Cl. CPC C09D 5/006
USPC 428/622; 428/216; 428/630; 428/621; 428/626

(57) ABSTRACT

The invention is related to optical coatings and may be used for significant reducing reflection of visible light from an external surface of displays or other devices for optical communication and information processing.

Anti-reflective coating in various embodiments consists of two or three layers which include one metal layer of a thickness ranging in various embodiments from 2 to 12 nanometers and one or two nonmetallic layers possessing refractive indices and thicknesses in certain ranges wherein the metal layer is placed either between the nonmetallic layer and a substrate or between the nonmetallic layers.

### BACKGROUND OF THE INVENTION

(a) Field of the Invention

The invention relates to optical coatings, in particular, to anti-reflective optical coatings and can be used to avoid or largely decrease an ambient light reflection from displays and devices for optical communication and information processing.

(b) Description of the Related Art

A well known anti-reflective coating on a substrate described e.g. in P. W. Baumeister “Optical Coating Technology”, page 1-3, FIG. 1-7 and page 4-11, section 4.3.2, published by SPIE, Washington, USA, 2004 includes one nonmetallic layer having a refractive index less than a substrate refractive index and of quarter-wave optical thickness (the optical thickness of layer is its physical thickness multiplied by the refractive index of the layer). This known anti-reflective coating decreases an ambient light residual reflection to 1.5-2% instead of 4-5% of a bare substrate. A drawback of this one-layer anti-reflective coating is a relatively high residual reflection.

Another well known anti-reflective coating on a substrate described e.g. in P. W. Baumeister “Optical Coating Technology”, page 4-12, section 4.3.3.1, published by SPIE, Washington, USA, 2004 includes first nonmetallic layer having a refractive index greater than the substrate refractive index and second nonmetallic layer having a refractive index less than the refractive index of the first nonmetallic layer, wherein the first nonmetallic layer is placed between the second nonmetallic layer and a substrate. This known anti-reflective coating decreases an ambient light residual reflection to 0.5-1% instead of 4-5% of a bare substrate. A drawback of this two-layer anti-reflective coating is a pronounced color of reflected light instead of a needed neutral tint.

Another well known anti-reflective coating on a substrate described, e.g. in P. W. Baumeister “Optical Coating Technology”, page 1-14, section 1.3.1.3, published by SPIE, Washington, USA, 2004 includes a set of alternate layers (not less than four layers) with a high and a low reflective indices. This known anti-reflective coating decreases an ambient light residual reflection to 0.1-0.5% instead of 4-5% of a bare substrate. A drawback of this multi-layer anti-reflective coating is a relatively high manufacture cost due to many layer deposition as well as adjustment difficulties.

Heat (infra-red range) reflecting but highly transparent in visible range panel is disclosed in U.S. Pat. No. 4,327,967. This panel includes one nonmetallic layer, having a refractive index more than 2, deposited on a glass substrate, gold layer deposited on this nonmetallic layer and other metals thin layer coating gold layer for reflection color neutrality. A drawback of this panel is relatively high reflection (>8%) in visible range.

### BRIEF SUMMARY OF THE INVENTION

An object of the invention is an anti-reflective coating supplying on a substrate providing an ambient light residual reflection for visible light as low as 0.1-0.5% at a needed neutral tint.

Another object of the invention while providing low ambient light residual reflection at a needed neutral tint is to minimize amount of layers (not more than three layers) anti-reflective coating consists of, which therefore ensures low cost.

According to the first embodiment of the invention, these objects for visible light are reached with anti-reflective coating on a substrate including one metal layer of a thickness ranging from 2 to 5 nanometers and one nonmetallic layer having reflective index ranging from 1.3 to 1.6 and a thickness ranging from 40 to 80 nanometers, wherein the metal layer is placed between the nonmetallic layer and the substrate.

According to the second embodiment of the invention, these objects for visible light are reached with anti-reflective coating on substrate, including one metal layer of a thickness ranging from 2 to 12 nanometers, first nonmetallic layer having refractive index not exceeding 1.7 and thickness ranges from 30 to 100 nanometers, second nonmetallic layer having refractive index greater than 1.7 and thickness ranges from 10 to 50 nanometers, with difference between refractive indices of second and first nonmetallic layers not less than 0.3, wherein second nonmetallic layer is placed on substrate, the metal layer is placed on second nonmetallic layer, and first nonmetallic layer is placed on the metal layer.

### BRIEF DESCRIPTION OF THE DRAWINGS

The invention is clarified by drawings which do not completely cover and do not limit the whole scope of claims of the presented technical solution, but only illustrate some embodiments of the anti-reflection coating.

FIG. 1 shows a first embodiment of anti-reflective coating consisting of one nonmetallic layer having refractive index of not greater than 1.6 and one metal layer of a thickness ranging from 2 to 5 nanometers placed between the nonmetallic layer and substrate.

FIG. 2 shows ambient visible light reflection spectrum of anti-reflective coating according to FIG. 1.

FIG. 3 shows a second embodiment of anti-reflective coating consisting of the first nonmetallic layer having refractive index of not greater than 1.7 and the second nonmetallic layer having refractive index of greater than 1.7 and one metal layer, wherein the second nonmetallic layer is placed on substrate, the metal layer is placed on second nonmetallic layer, first nonmetallic layer is placed on the metal layer.

FIG. 4 shows ambient visible light reflection spectrum of anti-reflective coating according to FIG. 3.

### DETAILED DESCRIPTION OF THE INVENTION

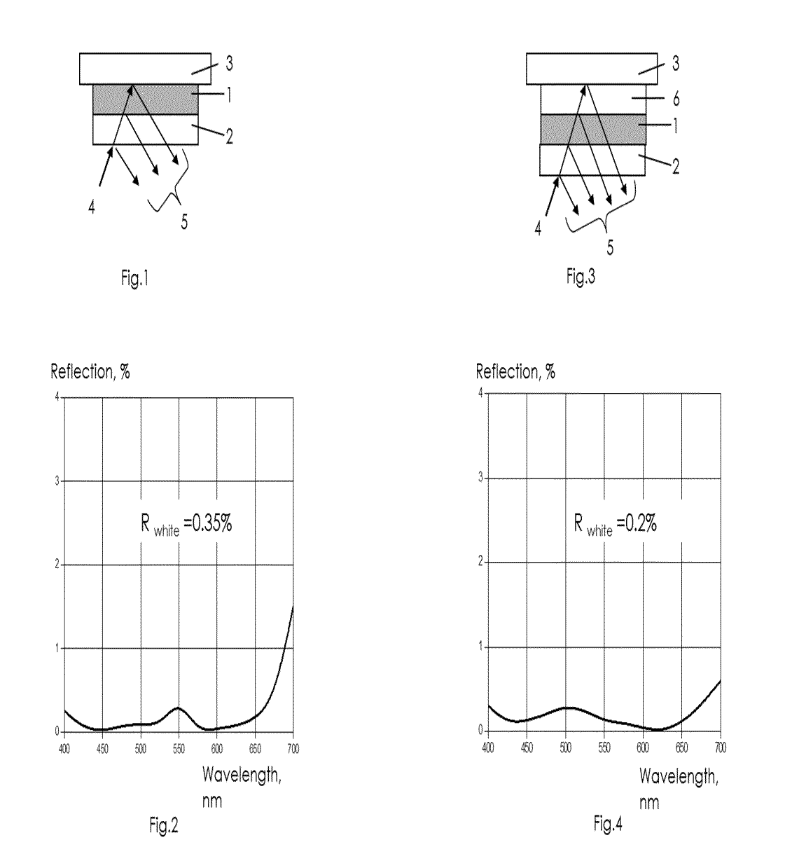

In FIG. 1 a first embodiment of anti-reflective coating on substrate 3 for visible light including one metal layer 1 of a thickness ranging from 2 to 5 nanometers and one nonmetallic layer 2 having reflective index ranging from 1.3 to 1.6 and a thickness ranging from 40 to 80 nanometers, wherein the metal layer 1 is placed between the nonmetallic layer 2 and a substrate 3 is shown.

Anti-reflective coating works as follows. The ambient white light 4 enters into the anti-reflective coating and is reflected from each interface: “air-nonmetallic layer 2”, “nonmetallic layer 2—metal layer 1”, “metal layer 1—substrate 3”. As a result of destructive interference of reflected light a total intensity of reflected light 5 is a very low at certain and properly chosen thickness and refractive index of the nonmetallic layer 1 and optical properties of metal and its thickness.

Metal layer, preferably, is made of the metals chosen from a group comprising: gold Au, silver Ag, aluminum Al, copper Cu, chromium Cr, titanium Ti, nickel Ni, manganese Mn, molybdenum Mo, bismuth Bi, tin Sn, rhodium Rh, platinum Pt, antimony Sb and any alloy or solid solution of mentioned substances. For better adhesion to the substrate 3 and to the mentioned nonmetallic layer 2 the metal layer 1 can include additionally sub-layers that have a thickness of not greater than 1 nanometer and made of materials selected from a group comprising: chromium Cr, titanium Ti, nickel Ni, vanadium V, zirconium Zr, hafnium Hf, niobium Nb, molybdenum Mo, and any mixture, alloy or solid solution of mentioned substances.

Thickness of metal layer 1 depends on which metal is used as well as on thickness and refractive index of nonmetallic layer 2 and ranges from 2 to 5 nanometers. Metal thickness lower than 2 nanometers has no significant influence on a visible reflection vs nonmetallic layer only. Metal thickness higher than 5 nanometers increases a visible reflection at “blue” and “red” wavelength ranges and, therefore, a total reflection of visible white light; also undesirable pronounced color of reflected light is generated.

Known methods are used for a deposition of metal layer 1 on substrate 3: thermal evaporation, evaporation by an electronic beam, deposition by pulverization, by an ion beam, by cathode pulverization, by vapor phase chemical deposition assisted by plasma, etc.

Nonmetallic layer 2 is made of substances selected from group comprising magnesium, calcium, barium, aluminum, lanthanum fluorides MgF₂, CaF₂, AlF₃, LaF₃, SiO₂, and any mixture, alloy, or solid solution of mentioned substances. Also organic polymer group comprising of acrylate- and fluoro-polymers are used. Other materials having refractive index not exceeding 1.6 and not mentioned here are possible to use.

Thickness of nonmetallic layer 2 depends on type of nonmetallic substance, mainly on its refractive index, as well as on thickness and type of metal layer 1 and ranges from 40 to 80 nanometers. Known methods are used for a deposition of nonmetallic layer 2: thermal evaporation, evaporation by an electronic beam, by pulverization by an ion beam, by cathode pulverization, by vapor phase chemical deposition assisted by plasma, etc. Also wet coating methods are used.

Substrate 3 (a display or other device outer surface) is made from a dielectric material, for example, from glass or polymer.

In FIG. 2 an ambient visible light reflection spectrum of anti-reflective coating according to FIG. 1 is depicted. It is clearly seen that a residual reflection of white light does not exceed 0.35% and has an almost neutral tint (due to a uniform reflection within the visible spectrum range).

In FIG. 3 a second embodiment of the invention is shown, This anti-reflective coating on substrate 3 for visible light, including one metal layer 1 of a thickness ranging from 2 to 12 nanometers, first nonmetallic layer 2 having refractive index not exceeding 1.7 and thickness ranges from 30 to 100 nanometers, second nonmetallic layer 6 having refractive index greater than 1.7 and thickness ranges from 10 to 50 nanometers, with difference between refractive indices of second and first nonmetallic layers not less than 0.3, wherein second nonmetallic layer 6 is placed on substrate 3, the metal layer 1 is placed on second nonmetallic layer 6, and first nonmetallic layer 2 is placed on the metal layer 1.

Anti-reflective coating works as follows. The ambient white light 4 enters into the anti-reflective coating and is reflected from each interface: “air-nonmetallic layer 2”, “nonmetallic layer 2—metal layer 1”, “metal layer 1—second nonmetallic layer 6”, “second nonmetallic layer 6—substrate 3”. As a result of destructive interference of reflected light the total intensity of reflected light 5 is very low with a proper choice of metal and nonmetallic materials, their thicknesses and refractive indices of nonmetallic layers 2 and 6.

Metal layer, preferably, is made of the materials chosen from group comprising gold Au, silver Ag, aluminum Al, copper Cu, chromium Cr, titanium Ti, nickel Ni, manganese Mn, molybdenum Mo, bismuth Bi, tin Sn, rhodium Rh, platinum Pt, antimony Sb and any mixtures, alloys, solid solutions or intermetallic compounds of mentioned substances. For better adhesion to the mentioned nonmetallic layer 6 and to the mentioned nonmetallic layer 2 the metal layer 1 can include additionally sub-layers that have a thickness of not greater than 1 nanometer and made of materials selected from group comprising chromium Cr, titanium Ti, nickel Ni, vanadium V, zirconium Zr, hafnium Hf, niobium Nb, molybdenum Mo, and any mixtures, alloys, solid solutions, or intermetallic compounds of mentioned substances.

Thickness of the metal layer 1 depends on sort of metal and on thicknesses and refractive indices of nonmetallic layers 2 and 6, and ranges from 2 to 12 nanometers. Metal thickness lower than 2 nanometers has no significant influence on a visible reflection vs nonmetallic layers only. Metal thickness higher than 12 nanometers increases a visible reflection at “blue” and “red” wavelength ranges and, therefore, a total reflection of visible white light; also undesirable pronounced color of reflected light is generated.

Methods used for a deposition of metal layer 1 on nonmetallic layer 6 are known: magnetron sputtering, thermal evaporation, evaporation by an electronic beam, by pulverization, by an ion beam, by cathode pulverization, by (plasma enhanced) chemical vapor deposition, etc.

Methods used for a deposition of nonmetallic layers 2 and 6 are known: magnetron sputtering, thermal evaporation, electronic beam evaporation, sol-gel, (plasma enhanced) chemical vapor deposition, etc.

Nonmetallic layer 2 having refractive index not exceeding 1.7 is made of materials selected from group comprising magnesium, calcium, barium, aluminum, lanthanum fluorides MgF₂, CaF₂, BaF₂, AlF₃, LaF₃, silicon dioxide SiO₂, and any mixture, alloy or solid solution of mentioned substances as well as organic polymer group comprising of acrylate- and fluoro-polymers. Also organic polymer group comprising of acrylate- and fluoro-polymers are used. Other materials having refractive index not exceeding 1.7 and not mentioned here are possible to use.

Thickness of nonmetallic layer 2 depends on sort of nonmetallic material, mainly on its refractive index and thickness and on sort of metal layer 1, and ranges from 30 to 100 nanometers. Second nonmetallic layer 6 having refractive index greater than 1.7 is made of materials selected from group comprising sapphire Al₂O₃, titanium dioxide TiO₂, zinc sulphide ZnS, tantalum pentoxide Ta₂O₅, zinc selenide ZnSe, gallium phosphide GaP, gallium nitride GaN, indium tin oxide ITO, niobium pentoxide Nb₂O₅, lead molibdate PbMoO₄, boron nitride BN, silicon nitride Si₃N₄, aluminum nitride AlN, silicon Si, germanium Ge, selenium Se, semiconductors A₃B₅ type, semiconductors A₂B₆ type, semiconductors A₅B₆ type (arsenic, antimony and bismuth chalcogenides) and any mixture or solid solution of mentioned substances.

Thickness of nonmetallic layer 6 depends on sort of nonmetallic materials of both layers 2 and 6 mainly on its reflective index and on thickness and sort of metal layer 1, and ranges from 10 to 50 nanometers.

Difference between refractive indices of second and first nonmetallic layers is not less than 0.3. Lower difference than 0.3 increases a visible reflection at “blue” and “red” wavelength ranges and, therefore, a total reflection of visible white light; also undesirable pronounced color of reflected light is generated.

Substrate (a display or other device outer surface) is made from dielectric material, for example, from glass or polymer.

In FIG. 4 an ambient light reflection spectrum of anti-reflective coating according to FIG. 3 is depicted. It is clearly seen that a residual reflection of white light does not exceed 0.2% and has a neutral tint (due to a uniform reflection within the visible spectrum range).

The technical result assured by aggregated attributes of the anti-reflective coating described here is: an ambient light residual reflection as low as 0.1-0.5% at needed neutral tint. Also anti-reflective coating consists of not greater than three layers which therefore ensures low cost.

This result is achieved by optimum balance of thicknesses of the nonmetallic layers, their refractive indexes, and the thickness of the metal layer.

What is claimed is:

1. Anti-reflective coating on substrate for visible light including:
a. one metal layer of a thickness ranging from 2 to 5 nanometers, and
b. one nonmetallic layer having reflective index ranging from 1.3 to 1.6 and a thickness ranging from 40 to 80 nanometers,
c. wherein the metal layer is placed between the nonmetallic layer and a substrate.

2. Anti-reflective coating according to claim 1, wherein the metal layer is made of materials selected from group comprising gold Au, silver Ag, aluminum Al, chromium Cr, titanium Ti, nickel Ni, manganese Mn, molybdenum Mo, bismuth Bi, tin Sn and any mixtures, alloys, solid solution or intermetallic compounds of mentioned substances.

3. Anti-reflective coating according to claim 2, wherein the metal layer includes additionally sub-layers of total thickness not exceeding 1 nanometer and made of metals selected from group comprising chromium Cr, titanium Ti, nickel Ni, vanadium V, zirconium Zr, hafnium Hf, niobium Nb, molybdenum Mo, and any mixture, alloy or solid solution of mentioned substances.

4. Anti-reflective coating according to claim 1, wherein the mentioned nonmetallic layer is made of materials selected from group comprising MgF₂, CaF₂, BaF₂, SiO₂, AlF₂, LaF₃ and any mixture or solid solution of mentioned substances, as well as organic polymer group comprising of acrylate- and fluoro-polymers.

5. Anti-reflective coating on substrate for visible light, including:
a. one metal layer of a thickness ranging from 2 to 12 nanometers, and
b. first nonmetallic layer having refractive index not exceeding 1.7 and thickness ranges from 30 to 100 nanometers, and
c. second nonmetallic layer having refractive index greater than 1.7 and thickness ranges from 10 to 50 nanometers with difference between refractive indices of second and first nonmetallic layers not less than 0.3,
d. wherein second nonmetallic layer is placed on substrate, the metal layer is placed on second nonmetallic layer, and first nonmetallic layer is placed on the metal layer.

6. Anti-reflective coating according to claim 5, wherein the metal layer is made of materials selected from group comprising gold Au, silver Ag, aluminum Al, chromium Cr, titanium Ti, nickel Ni, manganese Mn, molybdenum Mo, bismuth Bi, tin Sn and any mixtures, alloys, solid solution or intermetallic compounds of mentioned substances.

7. Anti-reflective coating according to claim 6, wherein the metal layer includes additionally sub-layers of total thickness not exceeding 1 nanometer and made of metals selected from group comprising chromium Cr, titanium Ti, nickel Ni, vanadium V, zirconium Zr, hafnium Hf, niobium Nb, molybdenum Mo, and any mixture, alloy or solid solution of mentioned substances.

8. Anti-reflective coating according to claim 5, wherein the first nonmetallic layer is made of materials selected from group comprising MgF₂, CaF₂, BaF₂, SiO₂, AlF₃, LaF₃ and any mixture or solid solution of mentioned substances, as well as organic polymer group comprising of acrylate- and fluoro-polymers.

9. Anti-reflective coating according to claim 5, wherein the mentioned second nonmetallic layer is made of materials selected from group comprising titanium dioxide TiO₂, zinc sulphide ZnS, tantalum pentoxide Ta₂O₅, zinc selenide ZnSe, gallium phosphide GaP, indium tin oxide ITO, gallium nitride GaN, niobium pentoxide Nb₂O₅, lead molibdate PbMoO₄, boron nitride BN, silicon nitride Si₃N₄, aluminum nitride AlN, silicon Si, germanium Ge, selenium Se, semiconductors A₃B₅ type, semiconductors A₂B₆ type, semiconductors A₅B₆ type (arsenic, antimony and bismuth chalcogenides) and any mixture or solid solution of mentioned substances.
